(19) United States
(12) Patent Application Publication
(10) Pub. No.: US 2004/0217610 A1
(43) Pub. Date: Nov. 4, 2004

(54) Coil hook

(76) Inventors: Bert D. Hollman, St. Joe, IN (US); Randall L. Leins, Auburn, IN (US)

Correspondence Address: Todd T. Taylor, TAYLOR & AUST, P.C., 142 S. Main St., P.O. Box 560, Avilla, IN, 46710, US

(21) Appl. No.: 10/427,375

(22) Filed: May 1, 2003

(51) Int. Cl. B66C 1/22

(52) U.S. Cl. 294/67.22

(57) ABSTRACT

A coil hook for handling a narrow coil of steel includes a lower jaw and an upper jaw. The lower jaw includes a generally vertical arm with a bottom end, and a bottom arm extending generally orthogonally from the bottom end of the vertical arm. The bottom arm has a distal end and an upwardly extending lip at the distal end. The upper jaw includes a collar disposed around the vertical arm and slidable in longitudinal directions of the vertical arm, and a top arm extending generally orthogonally from the collar in opposed relationship to the bottom arm. The top arm has a distal end and a downwardly extending lip at the distal end. A latch latches the collar to the vertical arm at a selected position.

### BACKGROUND OF THE INVENTION

1. Field of the Invention

The present invention relates to coil hooks for handling coils of flat material, and, more particularly, to coil hooks for lifting and moving narrow coils of steel.

2. Description of the Related Art

Steel is typically formed into a billet and subsequently processed into structural shapes such as I-beams, angle iron, C-channels, etc. For certain types of structural shapes such as sheet metal and the like, the steel is rolled into relatively wide sheets to a predetermined thickness and rolled into a large coil having a substantial width in the longitudinal direction of the coil (e.g., 3 to 5 feet). This type of large coil is lifted with a large, generally C-shaped coil hook. The lower jaw of the coil hook is simply placed at the inside diameter of the large coil and an overhead crane is used to lift and move the coil. When the coil is lowered and placed at a shipping location, such as at a shipping dock or on board a rail car or truck, the lower jaw of the coil hook merely disengages from the inside diameter of the coil and the coil hook is moved to another location for subsequent use. Since the coil has a relatively large width in the longitudinal direction, it is stable from end to end and does not topple over.

For the manufacture of other types of structural shapes such as an angle iron or C-channel, a narrow coil of steel having a desired thickness is placed at the upstream end of the manufacturing line and is unrolled for subsequent rolling and shaping into the desired structural shape. For example, a narrow coil having a width of approximately 8 inches in a longitudinal direction of the coil can be unrolled and used to form an angle iron with 4 inch flanges (possibly adjusted somewhat to accommodate for material deformation at the right angle bend between the flanges).

When using a narrow coil as described above, the coil may have an outside diameter of approximately 6 feet and an inside diameter of approximately 4 to 5 feet. It will be appreciated that when the coil is laced in an upright position for unwinding, it has a high center of gravity and narrow width which causes the coil to be relatively unstable and subject to toppling over. For this reason, such narrow coils are typically placed in a rack near the upstream end of the manufacturing line and are individually moved to the upstream end of the manufacturing line using an overhead crane. The rack has a simple construction consisting of vertical uprights defining storage slots therebetween for the coils. To place a coil in a rack, the overhead crane simply moves a coil into position above the rack and lowers the coil into a respective storage slot between adjacent vertical uprights. Occasionally, a coil may contact the top of one of the vertical uprights as it is being lowered into a storage slot adjacent to the upright. When this happens, it is possible for the coil to be lifted by the upright while the coil hook continues to be lowered by the overhead crane. This may result in the coil disengaging from the lower jaw of the coil hook and toppling over. Since the top of the vertical upright may be 4 to 5 feet high and the coil itself may be 5 to 6 feet in diameter and extremely heavy, this is not desirable.

Certain types of coil hooks used for handling large coils of steel include an upper clamping device which allows the steel coil to be oriented at any desired orientation, such as a vertical or horizontal orientation. Examples of such coil handling devices are disclosed by U.S. Pat. No. 3,680,907 (Siegwart) and U.S. Pat. No. 2,816,792 (Dixson). As is readily apparent these types of coil hooks are very complicated, heavy and expensive to manufacture and use.

It is also known to use a lifting hook for vertically oriented and stacked plates having an upper jaw which is pivotally and slidably moveable relative to a lower jaw. For example, U.S. Pat. No. 1,753,578 (Raymond) discloses a plate conveying hook having a pair of arms which are interconnected by cross arms. The top arms include a peculiar arrangement of pins which fit into recesses formed in the vertical upright extending from the lower jaw. An operator must lift the entire upper jaw and carefully place the pins into the corresponding recesses of the vertical uprights. The distal end of the upper jaw is then rotated into position above the plates and a thumb screw is used to lock the upper jaw into place. The upper jaw is thus cumbersome to position in place and may be pivoted away from the lower jaw. Given the very heavy weight of a narrow coil of steel (e.g., 2,000-3,000 pounds), there is no assurance that a movable top jaw as disclosed in Raymond '578 would not pivot away from the lower jaw and allow the heavy coil of steel to become disengaged and topple over.

What is needed in the art is a coil hook for a narrow coil of steel which effectively handles the coil and does not allow disengagement of the coil upon toppling or tipping of the coil.

### SUMMARY OF THE INVENTION

The present invention provides a coil hook with an upper jaw having a top arm with a downwardly extending lip which prevents disengagement of a minimum width coil upon tipping or partial toppling of the coil.

The invention comprises, in one form thereof, a coil hook for handling a narrow coil of steel. A lower jaw includes a generally vertical arm with a bottom end, and a bottom arm extending generally orthogonally from the bottom end of the vertical arm. The bottom arm has a distal end and an upwardly extending lip at the distal end. An upper jaw includes a collar disposed around the vertical arm and slidable in longitudinal directions of the vertical arm, and a top arm extending generally orthogonally from the collar in opposed relationship to the bottom arm. The top arm has a distal end and a downwardly extending lip at the distal end. A latch latches the collar to the vertical arm at a selected position.

An advantage of the present invention is that the coil hook has an upper jaw configured to maintain the positional relationship of a narrow coil relative to the coil hook.

Another advantage is that the coil hook is configured to accomodate narrow coils of varying widths and still prevent disengagement of the coil relative to the coil hook.

Yet another advantage is that the downwardly extending lip is configured with a predetermined length to accomodate the varying coil widths.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an embodiment of a coil hook of the present invention coupled with a narrow steel coil;

FIG. 2 is a partially fragmentary, side view of the coil hook shown in FIG. 1;

FIG. 3 is a fragmentary view as viewed along line 3-3 in FIG. 2;

FIG. 4 is a side view of the coil hook shown in FIGS. 1 and 2, with a narrow steel coil shown in a tipped position within the coil hook;

FIG. 5 is a partially fragmentary, side view of another embodiment of a coil hook of the present invention;

FIG. 6 is a fragmentary view of the coil hook of FIG. 5 as viewed along line 6-6;

FIG. 7 is a side view of yet another embodiment of a coil hook of the present invention; and

FIG. 8 is an end view of the coil hook shown in FIG. 7.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

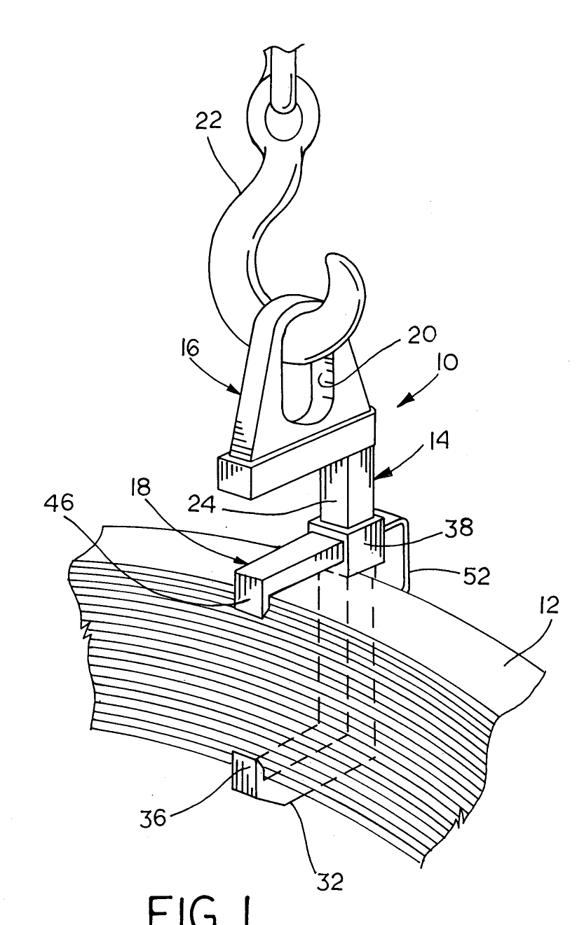

Referring now to the drawings, and more particularly to FIGS. 1-4, there is shown an embodiment of a coil hook 10 of the present invention for handling a narrow coil of steel 12. Coil hook 10 generally includes a lower jaw 14 coupled with a lifting eye 16, and an upper jaw 18 slideably movable to lower jaw 14, as will be described in more detail hereinafter.

Lifting eye 16 includes an opening 20 for coupling with a grappling hook 22 or the like for lifting and moving coil 12. For example, grappling hook 22 may be part of an overhead crane within a manufacturing facility which manufactures and/or processes strip steel rolled into coil 12.

Lower jaw 14 includes a generally vertical arm 24 having a top end 26 and a bottom end. 28. Top end 26 is connected to lifting eye 16. Vertical arm 24 includes a plurality of longitudinally spaced openings 30 in the form of holes which allow interlocking between lower jaw 14 and upper jaw 18, as will be described in more detail hereinafter. Vertical arm 24 has a generally square cross sectional shape in the embodiment shown, but may be differently configured such as with a rectangular cross sectional shape, etc.

Lower jaw 14 also includes a bottom arm 32 which is connected to and extends generally orthogonally from bottom end 28 of vertical arm 24. Bottom arm 32 has a distal end 34 opposite from vertical arm 24. An upwardly extending lip 36 at distal end 34 prevents disengagement of coil 12 upon tipping or toppling of coil 12. The distance between vertical arm 24 and upwardly extending lip 36 is selected to accommodate a narrow coil of steel 12 having a selected width within a range of widths. In the embodiment shown, the distance between upwardly extending lip 36 and vertical arm 24 is approximately 9.5 inches. Of course, this dimension as well as other dimensions of coil hook 10 may vary, depending on the particular application.

Upper jaw 16 includes a collar 38 and a top arm 40. Collar 38 is disposed around vertical arm 24 and is slideable in longitudinal directions of vertical arm 24. Collar 38 has an interior opening configuration with generally the same shape as but slightly larger than the cross sectional shape of vertical arm 24. In the embodiment shown, collar 38 has a generally square opening configuration allowing upper jaw 18 to slide up and down vertical arm 24, as indicated by arrows 42.

Top arm 40 is rigidly connected with and extends generally orthogonally from collar 38 in opposed relationship to bottom arm 32. Top arm 40 has a distal end 44 opposite from collar 38, and a downwardly extending lip 46 at distal end 44. Downwardly extending lip 46 lies generally coplanar with upwardly extending lip 36 in the embodiment shown.

A latch 48 is coupled with and latches collar 38 to vertical arm 24 at a selected position. Latch 48 includes a spring loaded pin 50 and a handle 52. Handle 52 is positioned around pin 50 in a generally vertical orientation, and allows one handed operation of latch 48. Pin 50 includes a cross member 54 allowing finger engagement by a user. Pin 50 has a distal end which is biased into a selected hole 30 formed in vertical arm 24. Thus, upper jaw 18 may be locked relative to lower jaw 14 using latch 48 to accommodate coils having varying dimensions between the inside diameter and the outside diameter, as shown in FIG. 1.

As described above, coil hook 10 is configured with a top arm 40 and bottom arm 32 which are long enough to accommodate a steel coil having a selected one of a range of widths. Regardless of the particular width of the steel coil, coil hook 10 is configured for handling a coil with a relatively narrow width. A narrow width coil is typically placed in a rack since it has a high center of gravity and may be likely to topple over if stored without the use of such a rack. When lowering the coil into the storage slot defined by the rack, it is possible that the coil may impact the top of the rack and begin to topple over rather than moving into the storage slot. Coil hook 10 of the present invention is configured to prevent disengagement with the coil even under such adverse conditions and regardless of the width of the coil received within coil hook 10.

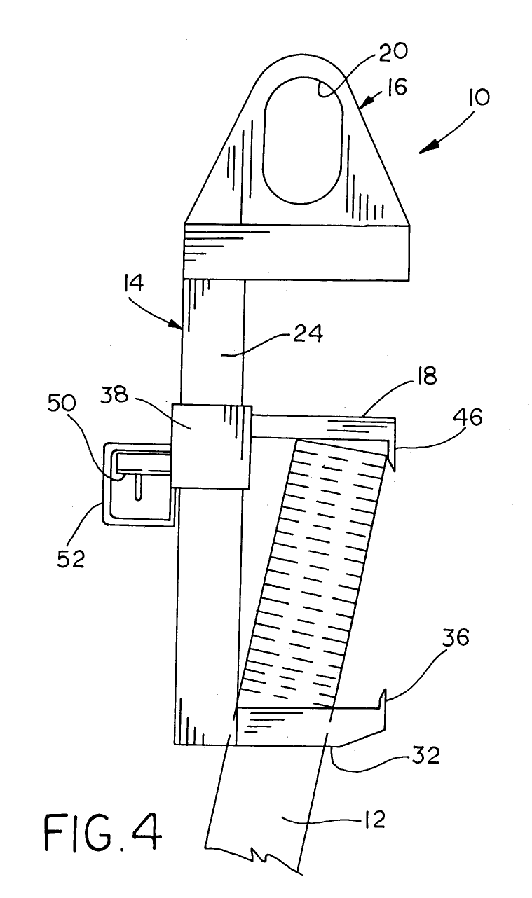

Referring to FIG. 4, a steel coil 12 having a width which is considerably less than the length of top arm 40 and bottom arm 32 is shown in a canted position such as might occur if the bottom of the coil engages the top of the rack in which it is placed. As coil hook 10 continues to move in a downward direction using the overhead crane, coil 12 may begin to topple to one side. Without upper jaw 18, the inside diameter of coil 12 could disengage from lower jaw 14. Upper jaw 18 is positioned closely adjacent to the outside diameter of coil 12 so that this does not happen. Nonetheless, coil 12 may become canted between upperjaw 18 and lower jaw 14 as shown in FIG. 4. Downwardly extending lip 46 has a sufficient length to prevent the outside diameter of coil 12 from disengaging with coil hook 10. It will be appreciated that the narrower the width of coil 12, the longer the length of downwardly extending lip 46. This length can either be calculated using trigonometric calculations, or empirically determined. Of course, the length of downwardly extending lip 46 should be configured with a margin of safety to ensure that disengagement between coil 12 and coil hook 10 does not occur.

From the foregoing description, it is apparent that upwardly extending lip 36 and downwardly extending lip 46 at all times maintain coil 12 between top arm 40 and bottom arm 32. In using this novel configuration of coil hook 10, it is thus unnecessary to configure top arm 40 such that it applies a clamping force against the outside diameter of coil 12. This in turn simplifies the construction and minimizes the weight associated with upper jaw 18. The reduced weight of upper jaw 18 in turn allows easier sliding action along vertical arm 24 with one handed operation by a user. All that is required is that top arm 40 be placed closely adjacent to the outside diameter of coil 12 so that upwardly extending lip 36 and downwardly extending lip 46 prevent disengagement of coil 12 from coil hook 10.

Additionally, from the foregoing description it will be appreciated that it is important that top arm 40 not be allowed to pivot in an upward direction relative to collar 38 or vertical arm 24. Accordingly, top arm 40 is rigidly affixed to collar 38.

During use, an overhead crane or the like is coupled with lifting eye 16 and used to lower coil hook 10 to a vertical position where it can be reached by and operator. The operator grabs handle 52 and pulls cross member 54 such that pin 50 becomes disengaged from a corresponding hole 30. Upper jaw 18 is then moved in an upward direction a distance which is sufficient to allow coil hook 10 to be engaged with a selected coil of steel. Maintaining a grasp on handle 52, the user places bottom jaw 32 against the inside diameter of the upstanding coil, with the sides of the coil being positioned between vertical arm 24 and upwardly extending lip 36. The operator again pulls on cross member 54 to disengage pin 50 and drops upper jaw 18 to the outside diameter of coil 12. Upper jaw 18 can be lifted slightly if necessary until pin 50 snaps into a biased position within a corresponding hole 30. The overhead crane is then operated to lift and move the selected steel coil 12. When placing the coil 12 in a rack, it is of course desirable for the coil to slide between uprights on the rack into the storage slot. However, in the event that the bottom of coil 12 contacts the top of an upright, it is possible for coil 12 to begin to tip or topple. Upwardly extending lip 36 and downwardly extending lip 46 prevent disengagement of coil 12 from coil hook 10 upon such tipping or toppling, as described above.

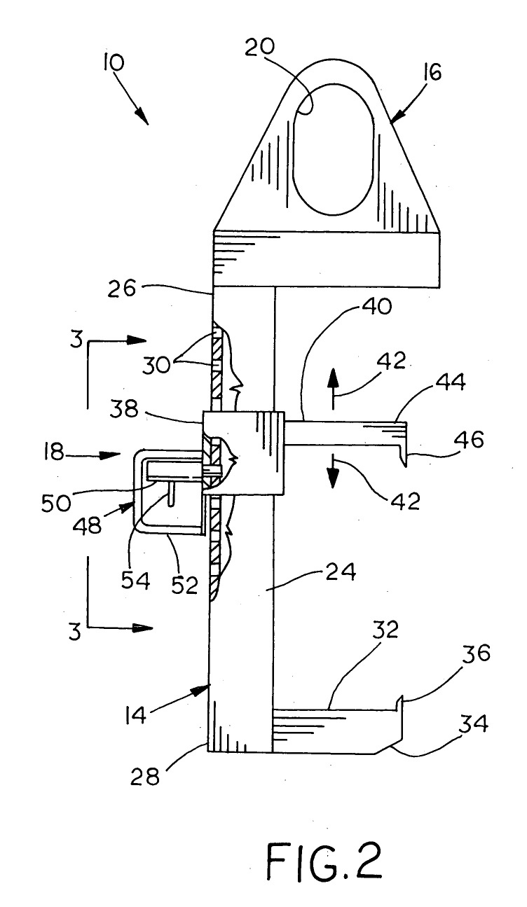

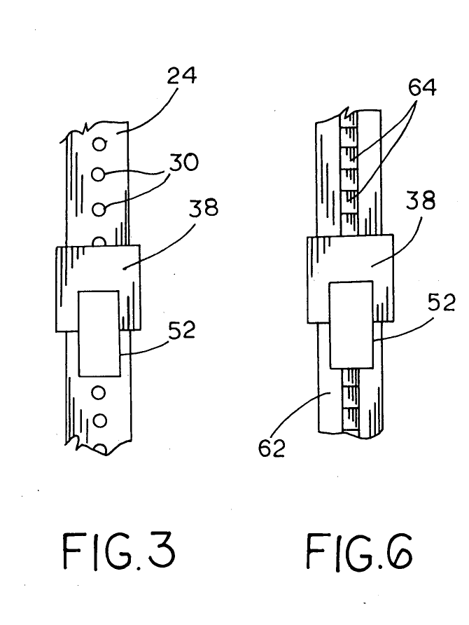

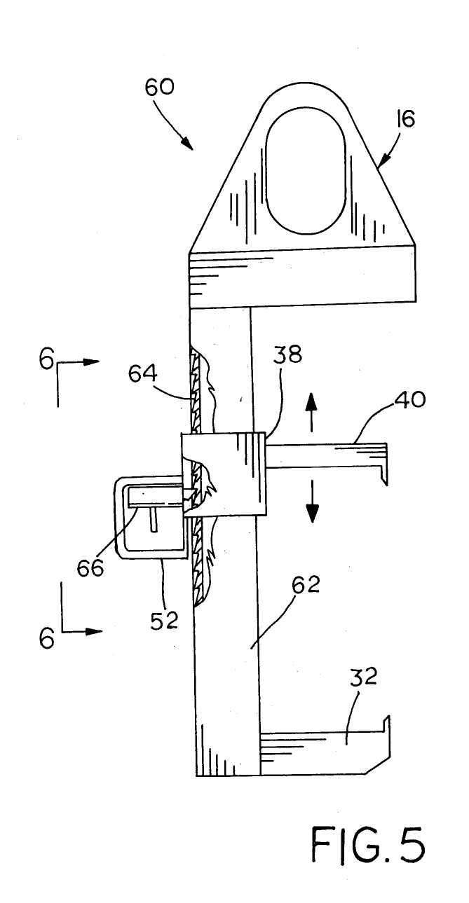

Referring now to FIGS. 5 and 6, there is shown another embodiment of a coil hook 60 of the present invention. Coil hook 60 is generally configured the same as coil hook 10 shown in FIGS. 1-4. The primary difference is that coil hook 60 includes a vertical arm 62 with a plurality of openings in the form of beveled notches 64, rather than circular holes 30 shown in FIGS. 2 and 3. Pin 66 likewise has a beveled distal end which engages beveled notches 64. Pin 66 and beveled notches 64 function to allow ratcheting movement of collar 38 in a downward direction without maintaining pin 66 in a retracted position. Collar 38 can only be moved in an upward direction by pulling on pin 66 to a retracted position.

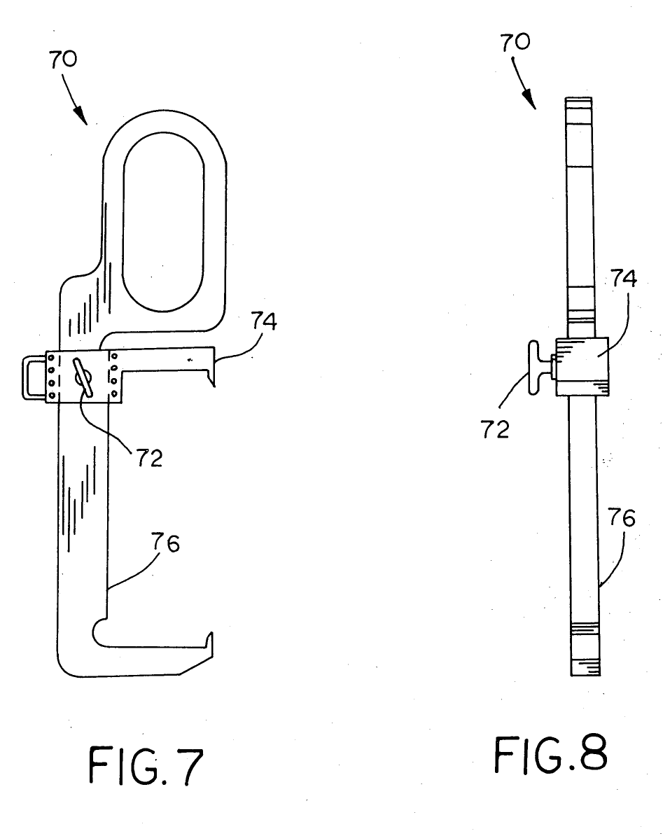

FIGS. 7 and 8 illustrate yet another embodiment of a coil hook 70 of the present invention. Coil hook 70 is again functionally similar to coil hooks 10 and 60 described above in many respects. The primary functional difference is that coil hook 70 includes a thumb screw 72 for locking upper jaw 74 in place relative to lower jaw 76.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A coil hook for handling a narrow coil of steel, comprising:
a lower jaw including a generally vertical arm with a bottom end, and a bottom arm extending generally orthogonally from said bottom end of said vertical arm, said bottom arm having a distal end and an upwardly extending lip at said distal end;
an upper jaw including a collar disposed around said vertical arm and slidable in longitudinal directions of said vertical arm, and a top arm extending generally orthogonally from said collar in opposed relationship to said bottom arm, said top arm having a distal end and a downwardly extending lip at said distal end; and
a latch for latching said collar to said vertical arm at a selected position.

2. The coil hook of claim 1, wherein said downwardly extending lip at said distal end of said top arm has a length sufficient to prevent disengagement of the coil upon tipping of the coil.

3. The coil hook of claim 2, wherein said top arm has a length configured to accomodate coils of different widths, including a minimum width, and said downwardly extending lip has a length associated with the minimum coil width.

4. The coil hook of claim 2, wherein said upwardly extending lip has a length which is approximately equal to said downwardly extending lip.

5. The coil hook of claim 1, wherein said top arm and said latch are configured such that said top arm lies closely adjacent to but does not clamp against the coil of steel.

6. The coil hook of claim 1, wherein said latch includes a spring loaded pin biased toward said vertical arm.

7. The coil hook of claim 6, wherein said vertical arm includes a plurality of longitudinally spaced openings engagable with said pin.

8. The coil hook of claim 7, wherein said plurality of openings comprise holes.

9. The coil hook of claim 7, wherein said plurality of openings comprise beveled notches allowing ratcheting movement of said collar in a downward direction.

10. The coil hook of claim 7, further including a handle positioned around said pin and allowing one handed operation of said pin.

11. The coil hook of claim 1, wherein said vertical arm has a cross sectional shape which is one of square and rectangular.

12. The coil hook of claim 1, wherein said top arm is rigidly attached to said collar.

13. A coil hook for handling a narrow coil of steel, comprising:
a lower jaw including a generally vertical arm with a bottom end, and a bottom arm extending generally orthogonally from said bottom end of said vertical arm, said bottom arm having a distal end and an upwardly extending lip at said distal end;
an upper jaw including a collar disposed around said vertical arm and slidable in longitudinal directions of said vertical arm, and a top arm extending generally orthogonally from said collar in opposed relationship to said bottom arm, said top arm having a distal end and a downwardly extending lip at said distal end, said top arm having a length configured to accomodate coils of different widths, including a minimum width, and said downwardly extending lip having a length associated with the minimum coil width to prevent disengagement of a selected coil upon tipping of the coil; and
a latch for latching said collar to said vertical arm at a selected position.

14. The coil hook of claim 13, wherein said top arm and said latch are configured such that said top arm lies closely adjacent to but does not clamp against the coil of steel.

15. The coil hook of claim 13, wherein said latch includes a spring loaded pin biased toward said vertical arm.

16. The coil hook of claim 15, wherein said vertical arm includes a plurality of longitudinally spaced openings engagable with said pin.

17. The coil hook of claim 16, wherein said plurality of openings comprise holes.

18. The coil hook of claim 16, wherein said plurality-of openings comprise beveled notches allowing ratcheting movement of said collar in a downward direction.

19. The coil hook of claim 16, further including a handle positioned around said pin and allowing one handed operation of said pin.

20. The coil hook of claim 13, wherein said top arm is rigidly attached to said collar.

21. A method of handling a narrow coil of steel, comprising the steps of:
providing a narrow coil having an inside diameter, an outside diameter, and a selected one of a plurality of widths ranging from a minimum width;
providing a coil hook, comprising:
a lower jaw including a generally vertical arm with a bottom end, and a bottom arm extending generally orthogonally from said bottom end of said vertical arm, said bottom arm having a distal end and an upwardly extending lip at said distal end;
an upper jaw including a collar disposed around said vertical arm and slidable in longitudinal directions of said vertical arm, and a top arm extending generally orthogonally from said collar in opposed relationship to said bottom arm, said top arm having a distal end and a downwardly extending lip at said distal end, said top arm having a length configured to accomodate said plurality of coil widths, including said minimum width, and said downwardly extending lip having a length associated with said minimum coil width; and
a latch for latching said collar to said vertical arm at a selected position;
spacing the top arm and the bottom arm at a distance greater than the distance between said inside diameter and said outside diameter;
placing the bottom arm at said inside diameter of a selected said coil having said minimum width, with said vertical arm and said upwardly extending lip on opposite sides of said coil;
sliding said top arm toward said bottom arm until said top arm is adjacent to said outside diameter of said coil, with said vertical arm and said downwardly extending lip on opposite sides of said coil;
latching said collar to said vertical arm using said latch; and
preventing disengagement of said minimum width coil from said coil hook using said downwardly extending lip and said upwardly extending lip.

22. The method of handling a narrow coil of steel of claim 21, wherein said latching step is carried out such that said top arm is adjacent to but does not clamp against said outside diameter.
